(19) United States
(12) Patent Application Publication
(10) Pub. No.: US 2016/0290578 A1
(43) Pub. Date: Oct. 6, 2016

(54) Method And Kit For Retrofitting Fluorescent Light Fixtures And Light Fixtures That Can Utilize New Communication Applications

(71) Applicant: Thomas W. Adkins, Toledo, OH (US)

(72) Inventor: Thomas W. Adkins, Toledo, OH (US)

(21) Appl. No.: 14/674,452

(22) Filed: Mar. 31, 2015

(51) Int. Cl. F21S 8/04; F21V 23/04; F21V 23/00; F21K 99/00

(52) U.S. Cl. CPC F21S 8/046; F21K 9/13; F21V 23/0435; F21V 23/002; F21Y 2101/02

(57) ABSTRACT

Retrofit lighting kits used in troffer style light fixtures allow the reuse of fluorescent lighting fixture housings, already in place, while retrofitting new assemblies that increase efficiency, add new communications applications, and reduce electrical usage as well as ongoing maintenance costs and new fixtures that can utilize the new communication applications. In the configuration sited, a new set of replacement parts, using channels, sockets, lamps, and a custom wiring harness, can be installed in the troffer style light fixtures used in home and office installations. The advantage of this retrofit kit allows the installation of specialized Light Emitting Diode lamps, to quickly replace the inefficient T8 and T12 lamps and service equipment, used in troffer style fixtures. Deployment of these kits, reduces electrical usage, reduces maintenance of the fixture, and eliminates “on-demand” servicing. LED lamps designed with multistage electronic circuitry can not only provide dimmable light, but would also allow the kit to act as a platform to enhance communications, through the use of sensors, Radio Frequency signaling (RF), or light based signaling, between the LED lamps in the kit, and other LED lamps, or other devices not residing in the fixture.

### BACKGROUND OF THE INVENTION

Commercial and industrial troffer style fluorescent light fixtures are inefficient to operate and require significant maintenance cost. These 2′ by 2′ and 2′ by 4′ suspended ceiling fixtures are the primary lighting chosen for offices, schools, government, and commercial venues. In the past, replacing such light fixtures required the removal and disposal of the fixture.

Depending on the way the fixture is installed, significant remodeling cost can also be incurred to repair the ceiling area where the fixtures were removed. The high cost associated with replacing these fixtures often exceeds the cost benefits of replacement, to the point where it is not economically feasible to replace the fixtures. For this reason, millions of these fixtures remain installed for 20 years or more. Accordingly, there is a need for a low cost retrofit replacement method that allows for upgrading such fixtures to more efficient lighting systems, reduced maintenance costs, and creates a platform for additional signaling features and applications available from the upgraded fixture. The method and retrofit kit allow the main fixture housing and the input wiring from the fluorescent fixture to be retained, which reduces installation and remodeling costs, and when populated with Light Emitting Diode (LED) Edison screw type lamps, of current and new designs, expands the light fixtures use for multiple communications applications.

### SUMMARY OF THE INVENTION

The present invention is directed to a concept and method that allows for the reuse of one, two or more existing fluorescent lighting fixture housings already in place, while retrofitting new assemblies that increase efficiency, reduce energy consumption and demand, and expand the use of the fixture for new non light oriented applications. The system consists of a retrofit specialized u-shaped light channel, using Edison screw type lamp sockets, which is placed into a troffer style suspended ceiling, light fixture, already in place. This system is lit with a new design of LED lamp that has abilities that exceed the standard attributes of dimming and occupancy sensing that current LED lamps exhibit for those familiar with the art. Use of specialized LED Lamps, mounted in Edison base screw type sockets, in upgraded troffer fixtures, using this system, allows for more efficient lighting, but also offer additional applications and benefits in security and communications. The system can also be used with fixtures that are designed to accept the new LED lamps with enhanced abilities. LED style lamps using the standard A style A 19 or A 21 shape have additional internal space for microcircuits and antenna arrays. This space can include a microcircuit method to create Radio Frequency, or RF signaling, which is well known in the art. In addition this LED lamp can be configured to allow high velocity light signaling that is not perceptible to the human eye, but can contain data or media, on a dual sided surface mount PCB board using already known technology. RF circuitry, as well as light signaling circuitry, as well as the LED driver technology, can be co-located within the base and globe of the LED package, and would be located in the closed lamp globe. An internal antenna system, within the enclosure, would allow the lamp to send or receive an RF signal, to or from other lamps, or to or from, a digital controller, located on, or off site. Radio frequency signaling is well known and is used commonly in wireless computer networks, wireless telephones, and computer network signaling. Such signaling is well known in the art. The LED lamp arrays can also be made to signal other lamps or controllers through high frequency light flashing. This form of signaling is also well known in the art. These new LED lamps would allow simple functions such as dimming or strobe lighting effects, but would also be designed to allow the creation of RF, signaling networks, as well as LED signaling networks. This operation is not possible within the current fluorescent linear troffer style ceiling fixtures, based on their design. By design, linear fluorescent lamps in use create an interference with RF signaling, eliminating these light fixtures, as currently wired from use as a RF communication device. Alternately, another function can be added to allow light signaling. The second PCB board, mounted within the lamp could be populated with Integrated circuit chips that allow the LED to flash at Very High Speeds, faster than human perception. This controller would allow the LED to energize and de-energize the LED circuit thousands of times per second. This energizing flash would allow light based communications between lamps, or other devices carrying voice media or data. The interaction created by these advanced LED lamps within this new system can act as a platform for a variety of communication devices, as well as a light source. One or more of these new LED lamps would be able to transmit signaling to other LED lamps, or to other devices. Multiple lamps in the Edison based sockets, placed in the u-shaped retrofit kit, would allow the creation of a wireless network, or Internet access ports that could be connected to the office computer local area network, or with a separate wireless access controller. This system would allow light, video, and audio transmission to local or wide area networks. Local area networks, as well as wide area networks, are well known in the art. Examples of the use of these new LED lamps in our system include, lamp to lamp signaling, lamp to security signaling, audio or video bi-directional transfer, data and voice transfer, light packet signaling, as well as local and wide area access points. Power for these transmissions is provided by the Edison based screw type socket, mounted on the u-channel, at the lamp's base. This allows the LED to have multiple functions while producing the desired light levels and addressing power supply issues. With a power system already in place, there is no need for an external transformer and/or driver for the multiple function LED lamps.

In one configuration of this invention, older troffer style fixtures, used primarily in office suspended ceiling environments, and often referred to as “drop in” fixtures, can be retrofitted with a lighting system comprised of specialized LED lamps in channels and sockets, to reduce operating costs, create and expand signaling, and broaden fixture usefulness. In addition, the system of the present invention can be used in light fixtures that are configured to accept the specialized LED lamps utilized in this invention.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a perspective view of a light fixture.

FIG. 2 is a perspective view of a light fixture.

FIG. 3 is a perspective view of a portion of a light fixture.

FIG. 4 is a perspective view of a portion of a light fixture.

FIG. 5 is a perspective view of a portion of a light fixture.

FIG. 6 is a perspective view of a portion of a light fixture.

FIG. 7 is a side elevational view of a high efficiency lamp.

FIG. 8 is a side elevational cross sectional view of a lamp.

FIG. 9 is a side elevational cross sectional view of a lamp.

FIG. 10 is a side elevational cross sectional view of a lamp.

### DETAILED DESCRIPTION OF THE INVENTION

The kit and method in this invention can be used to retrofit a 24 inch by 48 inch (two foot by four foot) troffer style light fixtures, as well as 24 inch by 24 inch (two foot by two foot) troffer style light fixtures using the original fixture shell and lens, and installing a set of ceramic sockets, specialized Light Emitting Diode (LED) lamps, specialized channels, and customized wiring harnesses.

The basic technology of converting an existing light fixture from fluorescent lamps is shown in U.S. Pat. No. 8,444,293 and the teaching of this reference is hereby incorporated by reference into this patent application.

The original fixture architecture in the 24-inch by 48-inch (two foot by four foot) design allows for three or four T8 or four T12, 48-inch (nominal) lamps, mounted side by side in the fixture. As an example, the F32 T8, or the F40 T12 lamps are generally found in these fixtures. Each fixture has six to eight of the clamp type dual pin lamp terminals and one or two ballasts, usually either magnetic, or electronic. In addition, each fixture has a diffuser lens or diffuser grid covering the lamps. The diffuser is the same approximate size as the fixture itself, and may have been placed in service with a frame mounting, or a rail mounting, system.

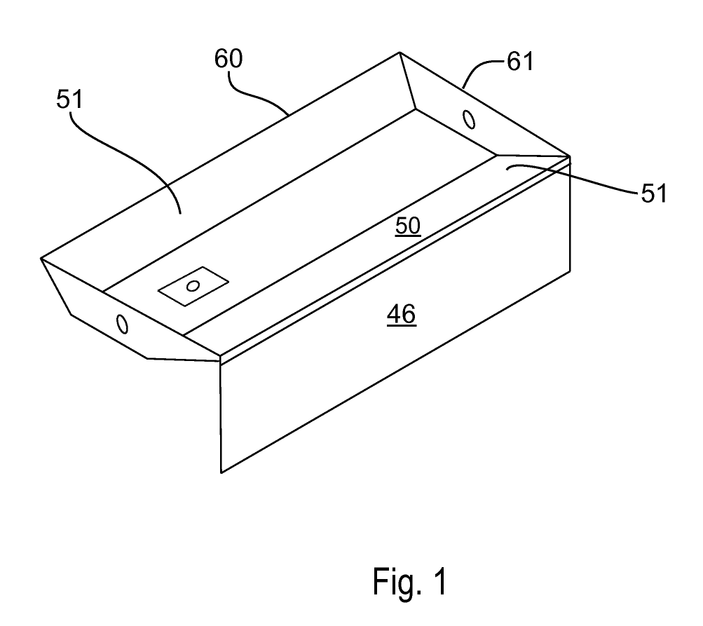

Retrofitting a 24 inch by 48 inch (two foot by four foot) rectangular drop-in troffer style light fixture 50, as shown in FIGS. 1, 3 and 4 begins as the fixture was originally installed. The fixture has a rectangular fixture box 48 and a removable fixture cover or diffuser lens 46. In this configuration, the fixture has a lighting ballast, a ballast cover, eight lamp terminals, and four fluorescent lamps, as is well known in the light fixture art and not shown in the drawings. The fluorescent lamps are usually rated at 32 to 40 watts each, and measure about 46 inches from electrode to electrode. They are normally described as T12 or T 8 fixtures. Energy use to illuminate these lamps is approximately 120 to 160 watts per fixture, when lit. There are several benefits, attained by the facility operator in using this new retrofit kit, including savings in electricity, maintenance, parts, as well as new communications applications

In this process, each fixture box 48 and diffuser lens 46 remains in place and the internal operational parts are removed and recycled. The removed parts include the ballast, lamps, sockets, and ballast cover. An advantage is that the fixture box is reused, not land filled. The empty fixture, with the diffuser lens retained, is completely cleaned out and wiped down to create the highest possible reflective surface remaining. The diffuser lens is completely cleaned as well.

Before the retrofit begins, the power is shut off and the circuit breaker for the lights is blocked and tagged. At this point the power feed conduit may already be in place, entering the fixture through a fixture end knock out plug, or more likely through an entry plate in the top of the fixture body. In many cases the power feed will be a flexible conduit, with insulated three, or four, conductor, wire. This configuration allows the use of either of the knock out plugs on the fixture end cap, or use of the top access plate, as a wiring supply access.

After properly locating the power feed, the provided retrofit kit electrical harness is connected to the new u-shaped channel in the fixture. The kit includes all needed fittings and attachments, as well as Edison style screw type sockets, wiring harness, prewired thermal controller, and grounding strap.

The three or four conductor wires are fed into the fixture body, and wired to the wiring harness provided, using wire nuts that are provided in the kit. To finish the installation, the ground wire is affixed to the flexible conduit in place, or to the green ground wire coming in the wiring feed.

LED A style lamps are now placed in the sockets, and tested for continuity as well as signaling, if signaling has been chosen for the installation. These lamps can be configured to produce LED lighting, exclusively or be configured for use in communication signaling. After completing these steps, the sockets are tested for continuity and grounding, and the circuit is reactivated. The diffuser panel is closed, and the retrofit is now complete.

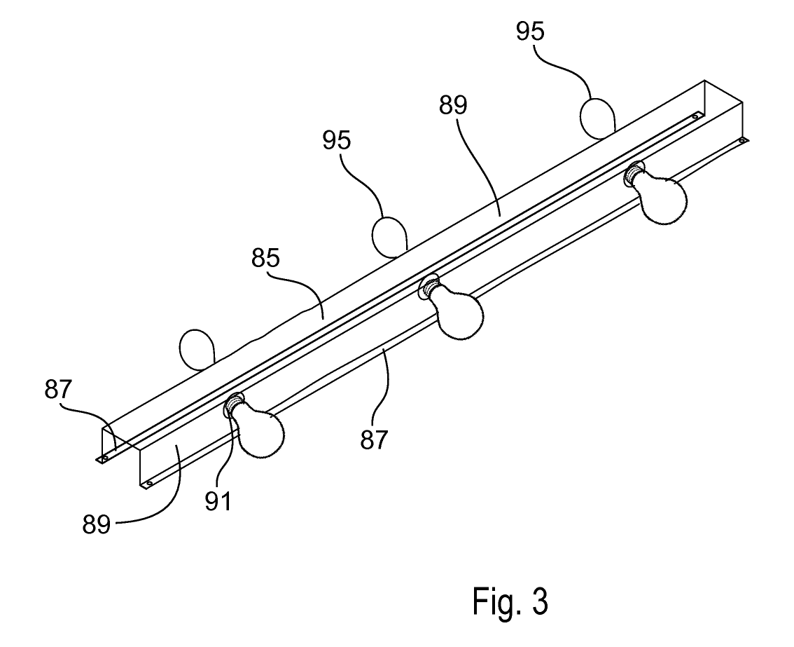

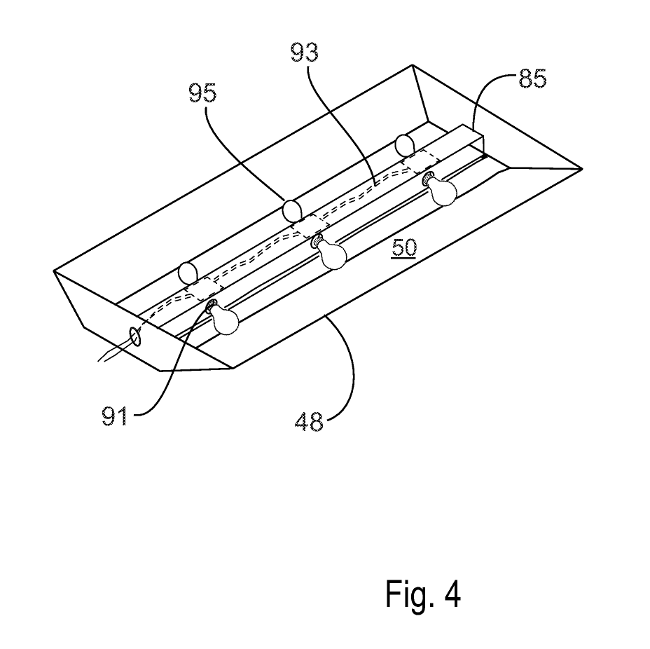

The installation for the 24-inch by 48-inch (two foot by four foot) troffer retrofit kit is described. In FIG. 3 and FIG. 4 using the same method and benefits previously described are expanded earlier in this installation. FIG. 3 shows a u-shaped power bar 85 that can be used with the kits of the present invention. The retrofit kit feature is used with the light fixture box 50 shown in FIG. 1 as described above.

Before starting the retrofit, the supply power is locked out, the internal parts are removed, and the fixture casing 48 and diffuser 46 (if present) are cleaned, before the installation of the retrofit kit begins. The power bar, a u-shaped insert 85, is positioned in the fixture box 48. The power bar u-shaped insert 85 has a flange 87 that extends from each leg 89 of the insert. The flange 87 is designed to engage the base of the fixture box 50. Suitable securing means such as screws, glue or welding can be used to secure the power bar u-shaped insert 85 to the base of the fixture box. A plurality of ceramic, or other suitable Edison style screw based sockets 91, are positioned on each of the legs 89 of the insert. The quantity of said sockets may vary, based on light or signaling requirements, in any specific installation. A wiring harness 93 is positioned between the legs 89 of the insert and operatively connected to the sockets 91. The custom wiring harness 93 is also secured to the power supply wire that is used to supply power to the light fixture box 48, using the original supply wiring. An LED lamp, 95 is positioned in each socket 91 to provide illumination to the desired level. The LED lamps 95 replace the less efficient fluorescent tube type of lights previously used. If the light fixture 50 has a lens or cover 46, such lens or cover can be repositioned on the light fixture after the installation of the insert and fluorescent lamps is completed. The power bar u-shaped insert 85 and new LED lamps 95 allow for reduced maintenance, reduced electrical usage and demand, and longer operational life. FIG. 4 shows the power bar 85 installed in the fixture box 48, with six or more sockets and LED Lamps present in this example. Other examples may have fewer sockets and lamps installed on the power bar 85, to vary desired light levels, or to change the signaling strength.

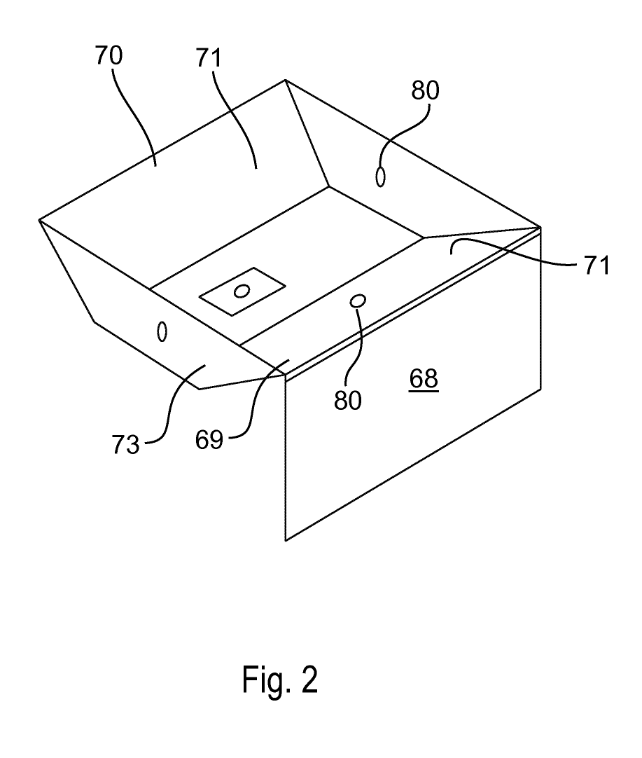

The kit and method of this invention can also be used to retrofit a 24 inch by 24 inch (two foot by two foot) troffer style light fixture 70, as shown in FIGS. 2, 5 and 6.

Retrofitting a 24-inch by 24-inch square (two foot by two foot) fixture 70 begins as the fixture was originally installed. In this configuration, the fixture generally has magnetic or electronic lighting ballast, a ballast cover, two mounting posts, four lamp sockets, and two u-line fluorescent lamps. These lamps are usually rated at 32 to 40 watts each. Energy use is approximately 75 to 90 watts per fixture, when lit. Some fixtures may have three, straight fluorescent lamps, as an alternate to the u-shaped lamps described here, and their wattage may vary in that case.

After retrofit to the new system, the facility operator attains several benefits. These include savings in maintenance and energy, as well as other operational cost centers, previously described. The energy used to run the fixture is dramatically reduced In addition, the fixture never requires rewiring due to ballast failure, after retrofit, as there is no freestanding ballast or plastic terminal ends after retrofit a maintenance crew can install and maintain the fixture going forward.

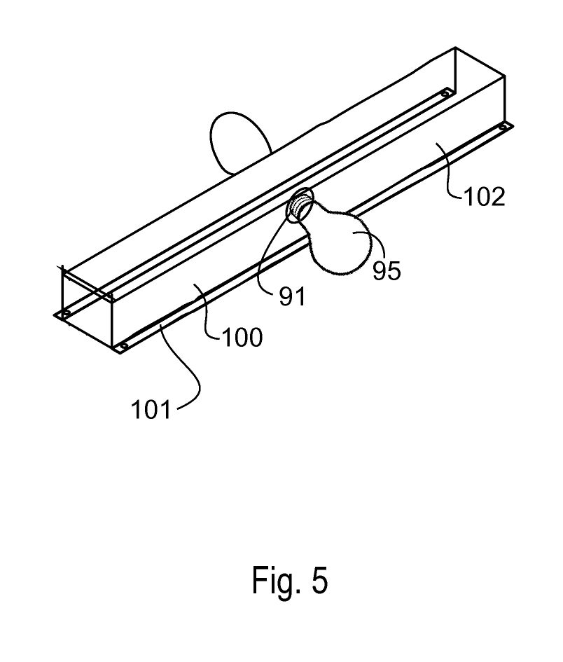

The installation in the 24-inch by 24-inch (two foot by two foot) troffer fixture retrofit kit is described in FIGS. 2, 5, and 6. The installation is similar to the installation previously described. The empty fixture box 69, with the lens 68 retained, is completely cleaned out and wiped down to create the highest possible reflective surface remaining. The same method and benefits previously described are exhibited in this installation. FIG. 5 shows a u-shaped custom power channel that can be used with the kits of the present invention. As described above, the power is locked out, the internal parts are removed, and the fixture box 69 and diffuser lens 68 (if present) are cleaned, before the installation of the retrofit kit begins. The power bar, a u-shaped insert 100, is positioned in the fixture box 69. The power bar u-shaped insert 100 has a flange 101 that extends from each leg 102 of the insert. The flange 101 is designed to engage the base 75 of the fixture box. Suitable securing means such as screws, glue or welding can be used to secure the power bar u-shaped insert 100 to the base of the fixture box. At least one Edison screw type lamp socket 91 is positioned on each of the legs 102 of the insert. The LED lamps 95 of the desired wattage are chosen and installed. These LED lamps may, or may not, have additional communication applications and features, as described in the example cited above, for use in the 2′ by 4′ retrofit kit. A wiring harness 93 is positioned between the legs 89 of the insert and operatively connected to the sockets 91. The wiring harness 93 is also secured to the power supply wire that is used to supply power to the light fixture 70, using the original supply wiring. An LED lamp 95 is positioned in each socket 91 to provide illumination for the light fixture 69. The LED lamps 95 replace the less efficient fluorescent tube type of lights previously used in the light fixture 69. These new LED lamps can only be placed in a troffer fixture using our system, as traditional troffer light fixtures do not have Edison screw base lamp sockets, and cannot accommodate LED Edison Base screw type lamps.

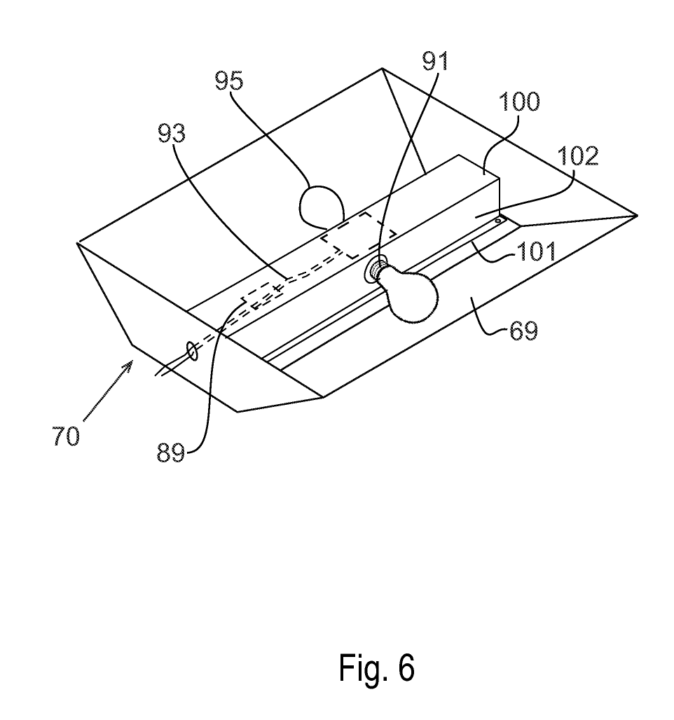

If the light fixture 69 has a lens or cover 68, such lens or cover can be repositioned on the light fixture after the installation of the insert and fluorescent lamps is completed. The power bar u-shaped insert 100 and new LED lamps 95 have the same installation and operational efficiencies as previously discussed but in addition, may offer more communication applications after retrofit. FIG. 6 shows the power bar 100 installed in the fixture box 69, with two sockets 91 and two LED lamps 95 present, in this example. Additional Edison screw type sockets are possible in this fixture configuration.

As previously described, the kit to retrofit a fixture may not be necessary if a light fixture is used that can accommodate the features of the new design LED lamps. Currently such fixtures are not available in the marketplace.

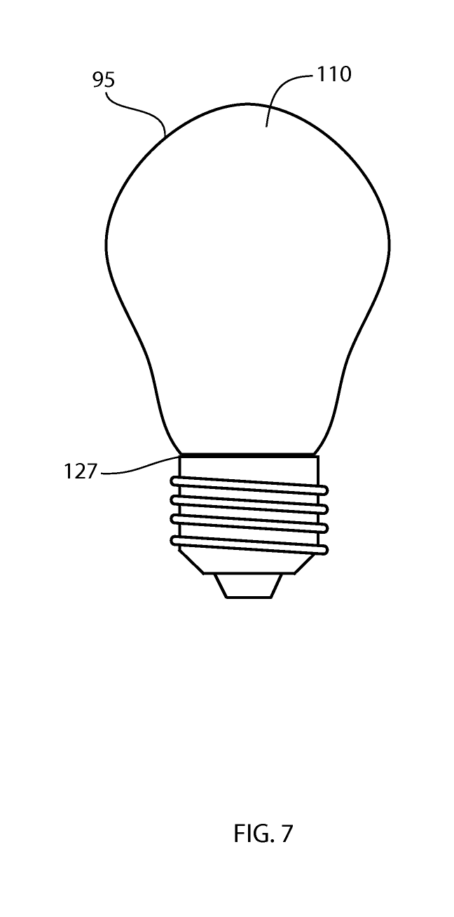

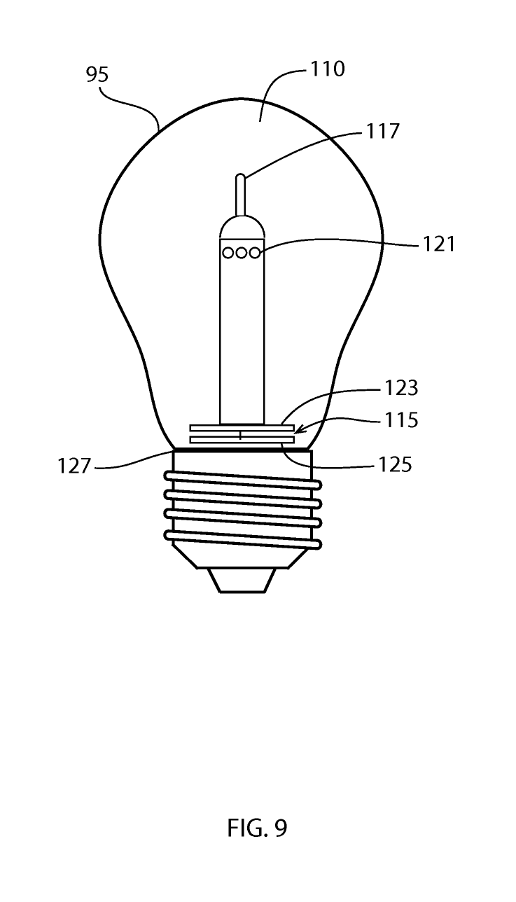

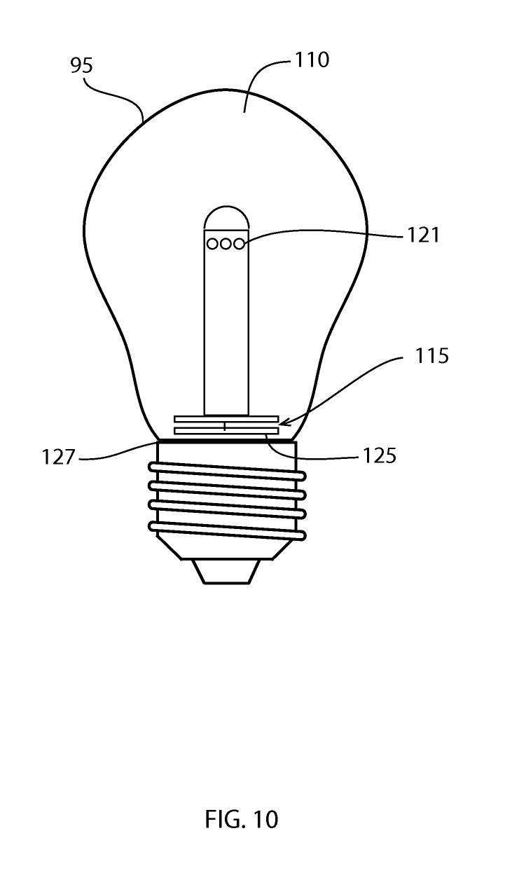

As shown in FIGS. 3-10, this system may be lit with a new design of LED lamp 95, which has abilities that exceed the standard attributes of dimming and occupancy sensing that current LED lamps exhibit for those familiar with the art. Use of specialized LED Lamps, mounted in Edison base screw type sockets, in upgraded troffer fixtures, using this system, allows for more efficient lighting, but also offer additional applications and benefits in security and communications. LED style lamps using the standard A style A 19 or A 21 shape have additional internal space 110 for microcircuits 115 and antenna arrays 117. This space can include a microcircuit method to create Radio Frequency, or RF signaling, which is well known in the art. In addition a specially designed LED lamp can be configured to allow high velocity light signaling 121 that is not perceptible to the human eye, but can contain data or media, on a dual sided surface mount PCB board using already known technology. In addition, a specially designed LED lamp can be configured with sensors that can, but are not limited to, measurement of environmental conditions. Examples of said sensors would be heat measurement, humidity measurement, or air quality measurement. These sensors can work in conjunction with other communication controllers to enhance safety, or environmental quality. Using sensors, as well as this method of information transfer for this purpose is well known in the art. These types of circuitry, as well as the LED driver circuitry 125, would be located in the base 127 of the LED package, or extending upward within the closed LED lamp globe. An internal antenna system 117, within the lamp's globe enclosure, would allow the lamp to send or receive RF signals, to or from other lamps, or, to or from, a digital controller, located on, or off site. RF signals can be produced in several frequency ranges. For example, the 2.4 gigahertz, and the 5.4 gigahertz bands are often used to create what are commonly called WIFI access points. Small chip packages using these technologies exist from several suppliers, such as Spirea AB of Sweden, Intel, Marvel, Broadcom (BCM series and others) and Qualcom, as well as a host of others. These wireless access chip packages increase in capability each year, as they decrease in size. The RF signals can be designed to create two-way wireless Internet voice and data communication, as well as video security data transmission applications. The RF signals are designed to offer linear, shaped, or multidirectional signaling systems. Many practical devices, such as smart phones, laptops, Tablets, and smart watches, as well as other devices that communicate wirelessly in the Internet of Things, use these chipsets and specifications. Most of these devices are, by design, compliant to the IEEE Specification known as the 802.11 standards, (802.11 A, B, G, N, and the coming 802.11ac). In our process, these WIFI RF band chip sets can be integrated into LED lamps to augment security, voice communication, and data transfer, when used in the invention herein described. These small chip packages can be surface mounted, or integrated by other means, directly into the LED A style lamp package, without interfering with the operation of the LED lamp for use as a light source.

RF signaling is currently used in office computer networks, wireless telephones, and computer network signaling.

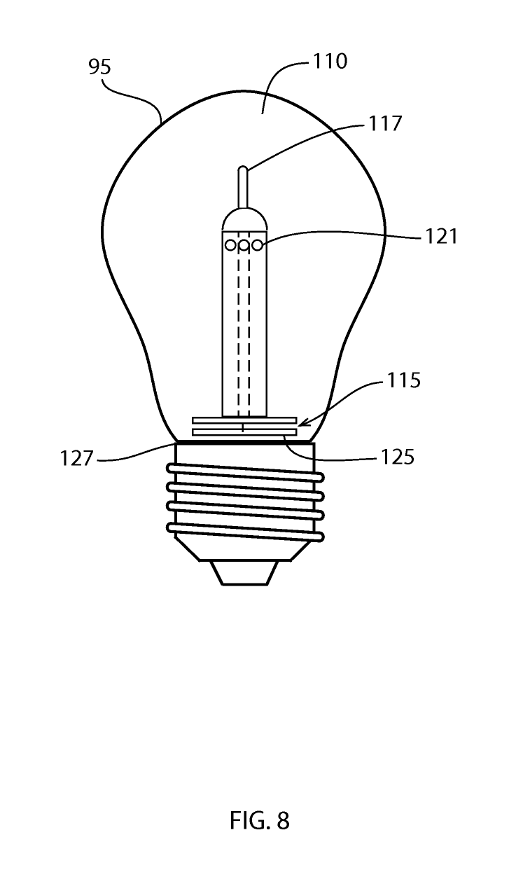

The LED lamp arrays can also be made to signal other lamps or controllers through digitized package, high frequency light flashing. This form of signaling is also well known in the art. These new LED lamps would allow simple functions such as dimming or strobe lighting effects, but would also be designed to allow the creation of RF, signaling networks, as well as LED signaling networks. This operation is not possible within the current fluorescent linear troffer style ceiling fixtures, based on their design. By design, linear fluorescent lamps in use create an interference with RF signaling, eliminating these light fixtures, as placed from use as a RF communication device. Alternately, or in addition to, the RF controller PCB board, another function can be added to allow light signaling. The primary or a secondary internal controller board could be populated with integrated circuit chips that allow the LED to flash at very high speeds, faster than human perception. This controller circuit as shown in FIGS. 8-10, would allow the LED to energize and de-energize the LED circuit thousands of times per second. This energizing flash would allow light based communications between lamps, or other devices carrying voice, media, or data. The interaction created by these advanced LED lamps within this new system can act as a platform for a variety of communications devices, as well as a light source. One or more of these new LED lamps would be able to transmit signaling to other LED lamps, or to other devices. Multiple lamps in the Edison based sockets, placed in the U shaped retrofit kit, and would allow the creation of wireless network or “mesh network” access points” and can act as Internet access points. This system would allow light, video, and audio transmission to local or wide area networks. Local Area Networks, as well as Wide Area networks, are well known in the art. Examples of the use of these New LED lamps in our system include, lamp to lamp signaling, lamp to security signaling, audio or video bi-directional transfer, data and voice transfer, light packet signaling, as well as Local and Wide Area Access Points. Power for these transmissions is provided by the Edison based screw type socket, mounted on the u-channel, at the lamp's base. This allows the LED to have multiple functions while producing the desired light levels and addressing power supply issues.

High frequency light signaling can be produced by LED lamps that are pulsing at high rates that can be read by other optical devices. The pulsed signals can carry data at rates up to 10 MB as of 2012, as presented by Wei Chen of Singapore at The IEEE Conference: Information Photonics and Optical Communications (IPOC). This speed of white light signaling had not been achieved previously, but this work showing advancement in the science of LED Light signaling, grew out of a study entitled Selected Areas In Communication (published Dec. 1 2009 in the IEEE Journal Volume 27 Issue nine pages 1664 to 1662) authored by Lubin Zing, Department of Engineering Science, Oxford University as well as 7 other distinguished colleagues. This study finds that solid-state lighting is a rapidly finding application, due to the reliability and predicted high efficiency of these devices. White LED sources that are typically used for general illumination can also be used for data transmission using Visible Light Communications (VLC). One of the key challenges is the limited modulation bandwidth of sources. However, as a room would typically be illuminated by an array of LED's there is potential for parallel data transmission. Using Optical Multiple In Multiple out network topology techniques, is attractive for achieving high data rates. Subsequently to the original work done by Wei Chen, and his team, the Visual Light Communication Consortium (VLCC) was formed 2009. This Consortium now consists of over 20 companies, including, but not limited to Samsung, Sony, Casio, as well as The Information Systems Research Institute, and the Coast Guard Research Center. The VLC Consortium is led by Chairman Eun Tae Won; research scientist at the Samsung Corporation. The mission of the VLCC is to define standards for visual light communications. This work is now in its fifth revision, as of 2015, and is well along in establishing standards for the VLC format. This proposed IEEE standard is referred to as 802.15.7. It remains as yet uncertified as a standard, but the science of LED based VLC has moved forward in Europe, the USA, and Japan. MIMO, which was the first method found and tested has been broadened to test several other methods to use LED white light in signaling. These include, but are not limited to R&D in CDMA (Code Division Multiple Access), LED light signaling (Oxford University), LOS light signaling (Line of Sight), as well as NLOS (Non-line of sight) light signaling, (University of California). VLC is becoming more mainstream as it does not have the same regulatory limitations that control WIFI transmissions using the regulated Radio Frequency bandwidth at 2.4 GHZ, and 5 GHZ. This new VLC technology can be used independently or in conjunction with WIFI, as a complement, or a possible future replacement for WIFI bi-directional signaling and sensing transmissions.

The angled side wall 51, 71 of the light fixtures provide a good surface to reflect RF or light signals from the LED lamps. The angled side walls of the light fixtures reflect the signals and expand the width or range of the signals. The reflected signals allow the LED lamps to have an improved range of signal coverage without increasing the power of the signal. The wall 51, 71 are usually angled from a vertical plane from about 5° to about 45° with a preferred range from about 10° to about 30°.

It is important to understand that this evolving technology is proven to create LED Lamp signaling, but not highly implemented due to bandwidth issues, as well as the lack of LED lighting systems capable of testing an LED lamp signaling network model. The invention herein noted would provide a method in commercial and industrial locations to act as an installation platform for these specialized LED lamps, as the communication technology of LED light signaling is fully developed.

Light reaching the surface is dependent on the lumens created by the LED Edison style screw base lamp size installed. Change in the wattage of the LED lamp may reduce or increase light output, which may be desired in fixtures burning 24 hours a day. These LED lamps may be induced to dim, through the use of solid-state switch dimming, already known to those proficient in the art. In general, the overall energy used to run the fixture is reduced, as is the commercial power demand factor, when compared to the original installation.

Maintenance is also reduced. The fixture requires fewer fixture entries for lamp replacement, and much easier replacement of lamps can be done once inside the fixture. With the new retrofit kit in place, if one lamp fails, the balance of the lamps remain fully lit. This eliminates the need for “on demand” maintenance caused in standard 2, 3, or 4 lamp troffer fixtures, as when a lamp fails in the standard fixture, the fixture often dims, flickers, or buzzes. In addition, with the new kit in place, the fixture never requires rewiring due to ballast failure, after retrofit, as there is no freestanding ballast in the new configuration. Lamp replacement is simplified. Additional measurable savings is attained, as a maintenance crew can do the retrofit, and ongoing service, in most cases. In this example, the ceiling remains undisturbed. In a fixture replacement scenario, the ceiling may require additional repair and/or replacement, when these fixtures are moved, or disturbed.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. A replacement kit to convert troffer style fluorescent lighting fixtures with higher efficiency LED lamps designed to provide both light and additional applications comprising:
a central u-shaped channel for mounting in the troffer style fixture;
the u-shaped channel is designed to use a top mounted electrical feed normally used with troffer style;
at least one screw type socket, positioned on the u-shaped channel; the sockets being designed to accommodate high efficiency lamps; and
a wiring harness positioned in the u-shaped channel and connected to the sockets the electrical feed wiring supplied to the fixture.

2. The kit of claim 1, wherein the u-shaped channel has two legs that extend in the same direction from a base.

3. The kit of claim 2, wherein a flange is positioned on the end of each leg that is spaced apart from the base, the flange being designed to engage the lighting fixture.

4. The kit of claim 3, wherein securing means are used to secure the flanges to the lighting fixtures.

5. The kit of claim 1, wherein the high efficiency lamps are Edison screw type base, LED lamps.

6. The kit of claim 5, wherein the high efficiency lamps have circuitry to create light, as well as circuitry to create communications through Radio Frequency signaling.

7. The kit of claim 5, wherein the high efficiency lamps have circuitry to create light and circuitry to digitally transmit and receive high velocity flashing light signals to allow Light based communication signaling, that would be imperceptible to the lamp's user.

8. The kit of claim 5, wherein the high efficiency lamps having circuitry to create light and circuitry to access wireless local and wide area networks within range.

9. The kit of claim 5, wherein the high efficiency lamps have circuitry to create light and circuitry to access security networks, or alert same, through voice, data, or video, using on board radio frequency signaling, or light based signaling.

10. The kit of claim 5, wherein the high efficiency lamps have circuitry to create light as well as sensor circuits designed to access other outfitted LED lamps for use in control systems that adjust environmental conditions, in other interior or exterior locations.

11. The kit of claim 5, wherein the high efficiency lamps have circuitry to create light as well as circuitry to create a location based information network to control other devices.

12. The kit of claim 5, wherein the high efficiency lamps have circuitry to create light as well as circuitry that acts to sense changes in occupancy, or presence of smoke in the fixture area, and signals such information by radio frequency or light based communications.

13. The kit of claim 2, wherein the wiring harness is positioned between the legs of the u-shaped channel.

14. The kit of claim 2, wherein a lens is positioned on the lighting fixture to defuse light from the high efficiency lamps.

15. A lighting fixture with higher efficiency LED lamps designed to provide both light and additional application comprising:
at least one type socket, positioned in the fixture, the socket being designed to accommodate high efficiency lamps; and
a wiring harness positioned in the fixture and connected to the sockets the electrical feed wiring supplied to the fixture.

16. The fixture of claim 15, wherein a u-shaped channel is positioned in the fixture and has two legs that extend in the same direction from a base, the at least one socket being located on the u-shaped channel.

17. The fixture of claim 16, wherein the u-shaped channel is formed integrally with the base.

18. The fixture of claim 15, wherein the high efficiency lamps are Edison screw type base, LED lamps.

19. The fixture of claim 15, wherein the high efficiency lamps have circuitry to create light and circuitry to create communications through radio frequency signaling.

20. The fixture of claim 15, wherein the high efficiency lamps have circuitry to create light and circuitry to digitally transmit and receive high velocity flashing light signals to allow light based communication signaling, that would be imperceptible to the lamp's user.

21. The fixture of claim 15, wherein the high efficiency lamps have circuitry to create light as well as circuitry to access wireless local and wide area networks within range.

22. The fixture of claim 15, wherein the high efficiency lamps have circuitry to create light as well as circuitry to access security networks, or alert same, through voice, data, or video, using on board radio frequency signaling, or light based signaling.

23. The fixture of claim 15, wherein the high efficiency lamps have circuitry to create light as well as sensor circuits designed to access other outfitted LED lamps for use in control systems that adjust environmental conditions, in other interior or exterior locations.

24. The fixture of claim 15, wherein the high efficiency lamps have circuitry to create light as well as circuitry to create a location based information network to control other services.

25. The fixture of claim 15, wherein the high efficiency lamps have circuitry to create light as well as circuitry that acts to sense changes in occupancy, or presence of smoke in the fixture area, and signals such information by radio frequency or light based communications.

26. The fixture of claim 16, wherein the wiring harness is positioned between the legs of the u-shaped channel.

27. The fixture of claim 16, wherein a lens is positioned on the lighting fixture to defuse light from the high efficiency lamps.
